(19) United States
(12) Patent Application Publication
(10) Pub. No.: US 2026/0343285 A1
(43) Pub. Date: Oct. 29, 2026

(54) UE REPORT FOR UPLINK SIMULTANEOUS MULTI-PANEL TRANSMISSION

(71) Applicant: Google LLC, Mountain View, CA (US)

(72) Inventors: Yushu Zhang, Beijing (CN); Chih-Hsiang Wu, Taipei (TW)

(21) Appl. No.: 19/111,515

(22) PCT Filed: Sep. 30, 2022
(86) PCT No.: PCT/CN2022/123633

§ 371 Date: Mar. 13, 2025

(51) Int. Cl. H04W 24/10; H04B 7/0413; H04B 7/06

(52) U.S. Cl. CPC H04W 24/10; H04B 7/0413; H04B 7/0626

(57) ABSTRACT

This disclosure provides systems, devices, apparatus, and methods, including computer programs encoded on storage media, for UE reports for STxMP. A UE (102) receives (604), from a network entity (104), control signaling for transmission (616) of a report associated with STxMP. The control signaling indicates at least one of a reporting quantity of uplink beams for the report, one or more downlink report for STxMP reference signals to be measured for the report, prohibit timer information transmission (616) of the report, or an uplink resource for the transmission (616) of the report. The UE transmits (616), to the network entity (104) based on a triggering condition, the report in conformance with the control signaling. The report corresponds to at least one of a beam report for STxMP or a panel status update report for STxMP.

### TECHNICAL FIELD

The present disclosure relates generally to wireless communication, and more particularly, to user equipment (UE) reports regarding simultaneous uplink transmissions from multiple panels of a UE.

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture might provide increased data rates, decreased latency, and/or increased capacity compared to other types of wireless communication systems.

Wireless communication systems, in general, may be configured to provide various telecommunication services (e.g., telephony, video, data, messaging, broadcasts, and so on.) based on multiple-access technologies, such as orthogonal frequency division multiple access (OFDMA) technologies, that support communication with multiple UEs. Improvements in mobile broadband have been useful to continue the progression of such wireless communication technologies. For example, a user equipment (UE) that activates multiple uplink transmission panels simultaneously might experience higher throughput or lower error rate in certain situations. In other situations, however, UE transmission on multiple antenna panels may result in a degradation in performance or power efficiency without significant throughput or error rate benefits.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A network entity, such as a base station or a unit of a base station, may schedule a user equipment (UE) to simultaneously transmit uplink signals via more than one beam if the UE includes multiple antenna panels. Such techniques may be known as simultaneous transmission from multiple panels (STxMP). When the UE has multiple panels, repeatedly activating the multiple physical uplink panels for STxMP might increase power consumption at the UE. In some cases, the UE might not receive a significant communications benefit from having the multiple uplink panels activated simultaneously. For example, if the UE is near a cell center with a strong single channel cluster, uplink beams of the UE might not have sufficient signal strength with a different channel cluster associated with a different network entity/base station that is farther away. In further examples, if multiple uplink beams of the UE have sufficient signal strength with a same channel cluster, the multiple beams might be associated with a same physical uplink transmission panel at the UE, rather than different physical uplink transmission panels for each beam. Thus, activating the multiple panels might cause a power efficiency degradation at the UE. Repeatedly activating and deactivating the multiple physical uplink panels might also cause the panels to overheat and degrade the performance of the UE.

In some examples, the network entity might have to be aware of a UE panel status change (e.g., activation/deactivation), because the status change might impact a transmission configuration indicator (TCI) state (e.g., the UE cannot transmit two beams simultaneously if only one panel is active) and/or a precoder selection (e.g., the UE cannot transmit uplink signals from a greater number of layers than associated with the activated panel(s)). While the network entity might trigger a beam report without receiving panel information from the UE, the trigger might not be appropriately timed for STxMP. For example, without panel status information, the network entity might not have information to configure appropriate timing (e.g., based on UE panel status changes) for a beam report periodicity and slot offset for the beam report. Aspects of the present disclosure address the above-noted and other deficiencies of network-triggered beam reports associated with the UE panel information by configuring UE-triggered beam reports/UE-assisted information reports associated with the UE panel information and/or control signaling for indicating a downlink precoder associated with UE panel status changes.

According to some aspects, the UE receives, from a network entity, control signaling for transmission of the report associated with STxMP. The control signaling indicates at least one of: a reporting quantity of uplink beams for the report, one or more downlink reference signals to be measured for the report, prohibit timer information for uplink scheduling requests, or an uplink resource for the transmission of the report. The UE transmits, to the network entity based on a triggering condition, the report associated with STxMP. The report corresponds to at least one of: a beam report for STxMP or a panel status update report for STxMP.

According to some aspects, the network entity transmits, to the UE, the control signaling with the indications described above. The network entity optionally transmits the downlink reference signals consistent with the relevant control signaling indication. The network entity receives, from the UE on the indicated uplink resources, the STxMP report as described above.

To the accomplishment of the foregoing and related ends, the one or more aspects correspond to the features hereinafter described and particularly pointed out in the claims. The one or more aspects may be implemented through any of an apparatus, a method, a means for performing the method, and/or a non-transitory computer-readable medium. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 illustrates a diagram of a wireless communications system that includes a plurality of user equipments (UEs) and network entities in communication over one or more cells.

FIGS. 2A-2B illustrate diagrams of downlink simultaneous reception from one or more transmission reception points (TRPs).

FIGS. 3A-3B illustrate diagrams for simultaneous transmission from multiple panels (STxMP) of a UE to one or more TRPs.

FIGS. 4A-4B illustrate uplink transmissions based on one or more strongest beams from a same panel of the UE.

FIG. 5 is a signaling diagram for a network-triggered beam report for STxMP.

FIGS. 6A-6B are signaling diagrams for UE-triggered beam/panel reports for STxMP.

FIGS. 7A-7B are signaling diagrams that illustrate procedures for communicating based on uplink multiple-input multiple-output (MIMO) parameters after a UE panel status change.

FIG. 8 is a flowchart of a method of wireless communication at a UE.

FIG. 9 is a flowchart of a method of wireless communication at a network entity.

FIG. 10 is a diagram illustrating an example of a hardware implementation for an example UE apparatus.

FIG. 11 is a diagram illustrating an example of a hardware implementation for one or more example network entities.

### DETAILED DESCRIPTION

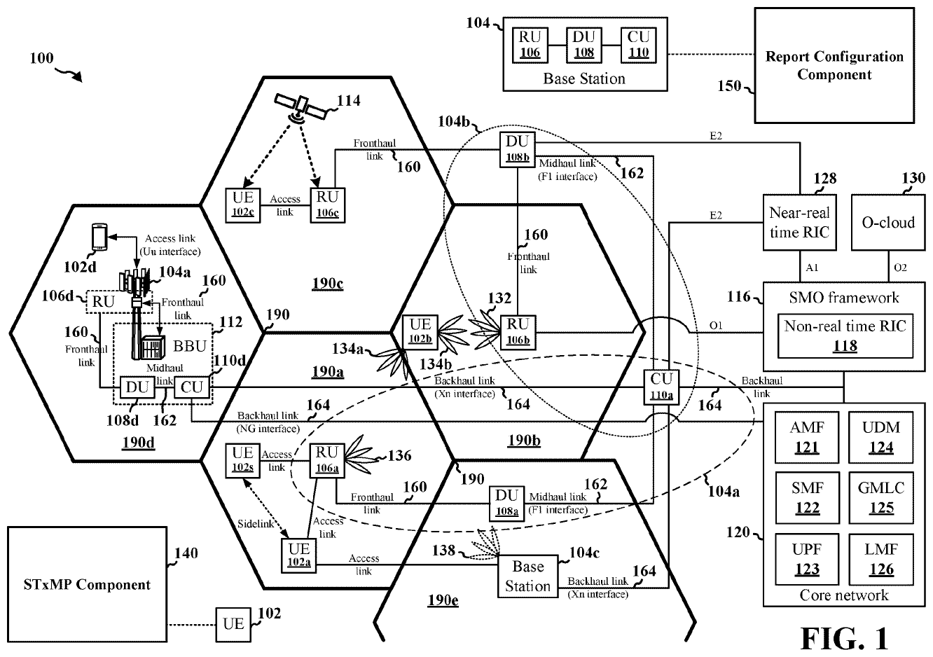

FIG. 1 illustrates a diagram 100 of a wireless communications system associated with a plurality of cells 190. The wireless communications system includes user equipments (UEs) 102 and base stations 104, where some base stations 104c include an aggregated base station architecture and other base stations 104a-104b include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links 162 based on F1 interfaces. The DUs 108a-108b may respectively communicate with the RU 106a and the RUs 106b-106c via respective fronthaul links 160. The RUs 106a-106c may communicate with respective UEs 102a-102c and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104c of the cell 190e simultaneously serve.

One or more CUs 110, such as the CU 110a or the CU 110d, may communicate directly with a core network 120 via a backhaul link 164. For example, the CU 110d communicates with the core network 120 over a backhaul link 164 based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an A1 link. The SMO framework 116 and/or the non-real time RIC 118 might also communicate with an open cloud (O-cloud) 130 via an O2 link. The one or more CUs 110 may further communicate with each other over a backhaul link 164 based on an Xn interface. For example, the CU 110d of the base station 104c communicates with the CU 110a of the base station 104b over the backhaul link 164 based on the Xn interface. Similarly, the base station 104c of the cell 190e may communicate with the CU 110a of the base station 104b over a backhaul link 164 based on the Xn interface.

The RUs 106, the DUs 108, and the CUS 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link 160 between the RU 106d and the baseband unit (BBU) 112 of the cell 190d or, more specifically, the fronthaul link 160 between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link 162. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104c of the cell 190e via cross-cell communication beams of the RU 106a and the base station 104c.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or cross-cell communication beams. For example, the UE 102b of the cell 190b may communicate with the RU 106a of the cell 190a via a third set of communication beams 134a of the UE 102b and an RU beam set 136 of the RU 106a. Both real-time and non-real-time features of control plane and user plane communications of the RUs 106 can be controlled by associated DUs 108. Accordingly, the DUs 108 and the CUS 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the 02 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an Ol link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the A1 interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the O2 link for deployment of the AI/ML models to the real-time RIC 128 via the A1 link. The near-real time RIC 128 may utilize the parameters and/or other information received from the non-real time RIC 118 or the SMO framework 116 via the A1 link to perform near-real time functionalities. The near-real time RIC 128 and the non-real time RIC 115 may be configured to adjust a performance of the RAN. For example, the non-real time RIC 116 monitors patterns and long-term trends to increase the performance of the RAN. The non-real time RIC 116 may also deploy AI/ML models for implementing corrective actions through the SMO framework 116, such as initiating a reconfiguration of the Ol link or indicating management procedures for the A1 link.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104c of cell 190d to transmit a downlink/forward link communication to the UE 102d or receive an uplink/reverse link communication from the UE 102d based on the Uu interface associated with the access link between the UE 102d and the base station 104c/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating bands referred to as frequency range 1 (FR1) and frequency range 2 (FR2). FR1 ranges from 410 MHz-7.125 GHz and FR2 ranges from 24.25 GHz-52.6 GHz. Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating bands have been identified to extend 5G NR communications above 52.6 GHz associated with the upper limit of FR2. Three of these higher operating bands include FR2-2, which ranges from 52.6 GHz-71 GHz, FR4, which ranges from 71 GHz-114.25 GHz, and FR 5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134b from the RU 106b in one or more receive directions of the UE 102b. In a further example, the UE 102b may also transmit an uplink beamformed signal to the RU 106b based on the second set of beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104c and a second base station 104b. For instance, the RU 106a of cell 190a may transmit a beamformed signal based on the RU beam set 136 to the base station 104c of cell 190e in one or more transmit directions of the RU 106a. The base station 104c of the cell 190e may receive the beamformed signal from the RU 106a based on a base station beam set 138 in one or more receive directions of the base station 104c. Similarly, the base station 104c of the cell 190e may transmit a beamformed signal to the RU 106a based on the base station beam set 138 in one or more transmit directions of the base station 104c. The RU 106a may receive the beamformed signal from the base station 104c of the cell 190e based on the RU beam set 136 in one or more receive directions of the RU 106a.

The base station 104 may include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a transmission reception point (TRP), a network node, a network entity, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104c may be referred to as a next generation-radio access network (NG-RAN).

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers include one or more location/positioning servers, which may include the GMLC 125 and the LMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1, in certain aspects, the UE 102 may include a simultaneous transmission from multiple panels (STxMP) component 140 configured to receive, from a network entity, control signaling for transmission of a report associated with STxMP, where the control signaling indicates at least one of a reporting quantity of uplink beams for the report, one or more downlink reference signals to be measured for the report, prohibit timer information for the transmission of the report, or an uplink resource for the transmission of the report; and transmit, to the network entity based on a triggering condition, the report in conformance with the control signaling, where the report corresponds to at least one of a beam report for STxMP or a panel status update report for STxMP.

In certain aspects, the base station 104 or a network entity of the base station 104 may include a report configuration component 150 configured to transmit, to a UE, control signaling for reception of a report associated with STxMP of the UE, where the control signaling indicates at least one of a reporting quantity of uplink beams for the report, one or more downlink reference signals to be measured for the report, prohibit timer information for the reception of the report, or an uplink resource for the reception of the report; and receive, from the UE based on a triggering condition, the report in conformance with the control signaling, where the report corresponds to at least one of a beam report for STxMP or a panel status update report for STxMP.

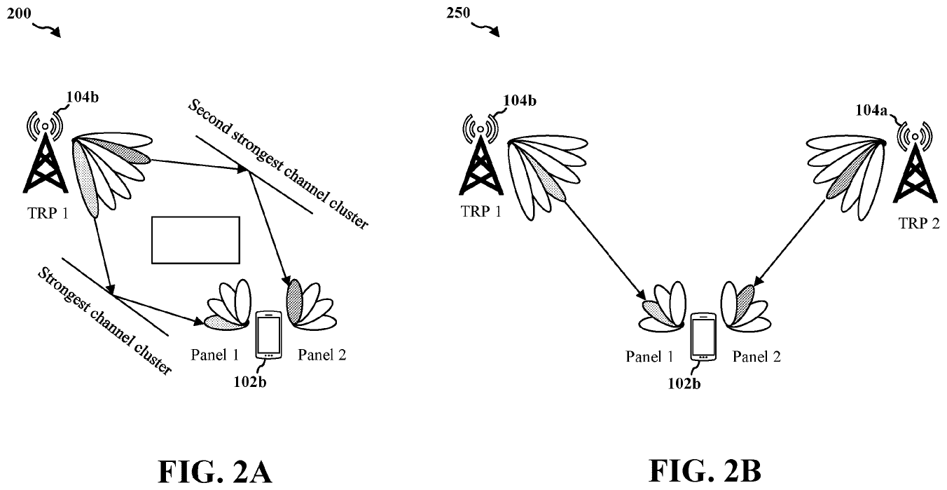

Accordingly, FIG. 1 describes a wireless communication system that may be implemented in connection with aspects of one or more other figures described herein, such as aspects illustrated in FIGS. 2A-7B. Further, although the following description may be focused on 5G NR, the concepts described herein may be applicable to other similar areas, such as 5G-Advanced and future versions, LTE, LTE-advanced (LTE-A), and other wireless technologies.

FIGS. 2A-2B illustrate diagrams 200-250 of downlink simultaneous reception from one or more TRPs (e.g., base stations 104a-104b). A cell radius/coverage area of the base stations 104a-104b might be based on a link budget. The “link budget” refers to an accumulation of total gains and losses in a system, which provide a received signal level at a receiver, such as a UE 102b. The receiver may compare the received signal level to a receiver sensitivity to determine whether a channel provides at least a minimum signal strength for signals communicated between the receiver and a transmitter (e.g., the UE 102b and the base stations 104a-104b).

In order to increase the link budget, the base stations 104a-104b and the UE 102b might perform an analog beamforming operation to activate a beam pair associated with an increased signal strength. Both the base stations 104a-104b and the UE 102b maintain a plurality of beams that may be used for the beam pair. A beam pair that decreases a coupling loss might result in an increased coverage gain for the base stations 104a-104b and the UE 102b. “Coupling loss” refers to a path loss/reduction in power density between a first antenna of a base station 104a-104b and a second antenna of the UE 102b, and may be indicated in units of decibel (dB). Beam selection procedures for the beam pair activated by the base stations 104a-104b and the UE 102b might be associated with one or more of beam measurement operations, beam measurement reporting, or beam indication procedures.

A first type of beam reporting might correspond to non-group based beam reporting, where the base stations 104a-104b can configure the UE 102b to measure and report a layer 1 reference signal receiving power (L1-RSRP) or a layer 1 signal-to-interference plus noise ratio (L1-SINR) for a set of downlink reference signals from the base stations 104a-104b. The downlink reference signals may correspond to synchronization signal blocks (SSBs), channel state information-reference signals (CSI-RSs), etc. The UE 102b might report the L1-RSRP or the L1-SINR in each beam reporting instance for up to 4 SSBs or 4 CSI-RSs. A second type of beam reporting might correspond to group-based beam reporting, where the base stations 104a-104b can configure the UE 102b to measure and report the L1-RSRP or the L1-SINR for multiple groups of SSBs or CSI-RSs. Each beam group may include 2 SSBs or 2 CSI-RSs that that the UE 102 can receive simultaneously.

The UE 102b can use two different panels to receive the two downlink beams simultaneously from the one or more TRPs (e.g., base stations 104a-104b). For example, the UE 102b may receive the two downlink beams from the one or more TRPs, as illustrated in the diagrams 200-250. That is, the UE 102b may receive a first downlink beam of a strongest channel cluster associated with the base station 104b and a second downlink beam of a second strongest channel cluster associated with a same base station 104b, such as when the downlink beams/signals are reflected around an object, as illustrated in the diagram 200. Alternatively, the UE 102b may receive a first downlink beam of a strongest channel cluster (e.g., associated with the first base station 104b) and a second downlink beam of a second strongest channel cluster (e.g., associated with a second base station 104a), as illustrated in the diagram 250. In either case, the UE 102b generates and transmits a beam report to the one or more TRPs after receiving the two downlink beams from the one or more TRPs, such that the one or more TRPs (e.g., base stations 104a-104b) can transmit control signaling to the UE 102b for beam indication.

The base stations 104a-104b may indicate a transmission configuration indicator (TCI) state to the UE 102b via downlink signaling. For example, the base stations 104a-104b can indicate TCI updating signaling through a medium access control-control element (MAC-CE) or downlink control information (DCI). “TCI state” refers to a set of parameters for configuring a quasi co-location (QCL) relationship between one or more downlink reference signals and corresponding antenna ports. For example, the TCI state might be indicative of a QCL relationship between downlink reference signals in a channel state information-reference signal (CSI-RS) set and physical downlink shared channel (PDSCH) demodulation reference signal (DMRS) ports. Due to the theorem of antenna reciprocity, a single TCI state might provide beam indications for both downlink channels/signals and uplink channels/signals.

Beam indication techniques based on TCI signaling may include joint beam indication or separate beam indications. “Joint beam indication” refers to a single/joint TCI state that is used to update the beams for both the downlink channels/signals and the uplink channels/signals. For example, the base stations 104a-104b can indicate a single/joint TCI state in downlink TCI signaling that is configured based on a DLorJointTCIState parameter to update the beams for both the downlink channels/signals and the uplink channels/signals. For TCI signaling based on the joint TCI state, the base stations 104a-104b may transmit an SSB or CSI-RS to indicate the QCL relationship between the downlink channels/signals and a spatial relation of the uplink channels/signals. In a first aspect, the transmitted TCI update signaling may correspond to a joint beam indication for both the downlink channels/signals and the uplink channels/signals.

“Separate beam indications” refers to a first TCI state that is used to update a first beam for the downlink channels/signals and a second TCI state that is used to update a second beam for the uplink channels/signals. For example, the base stations 104a-104b can indicate the first TCI state in the downlink TCI signaling configured based on the DLorJointTCIState parameter to update the first beam for the downlink channels/signals, and may indicate the second TCI state in further downlink TCI signaling configured based on an UL-TCIState parameter to update the second beam for the uplink channels/signals. If the base stations 104a-104b indicate the second TCI state (e.g., uplink TCI), the downlink reference signal may correspond to the SSB, the CSI-RS, etc. In examples where the second TCI state indicates an uplink reference signal (e.g., uplink TCI), the uplink reference signal may correspond to a sounding reference signal (SRS), which might indicate the spatial relation of the uplink channels/signals. In a second aspect, the transmitted TCI update signaling may correspond to either the downlink channels/signals or the uplink channels/signals based on the separate beam indications technique.

The base stations 104a-104b may configure a QCL type and/or a source reference signal for the QCL signaling. QCL types for downlink reference signals might be based on a higher layer parameter, such as a qcl-Type in a QCL-Info parameter. A first QCL type that corresponds to typeA might be associated with a Doppler shift, a Doppler spread, an average delay, and/or a delay spread. A second QCL type that corresponds to typeB might be associated with the Doppler shift and/or the Doppler spread. A third QCL type that corresponds to typeC might be associated with the Doppler shift and/or the average delay. A fourth QCL type that corresponds to typeD might be associated with a spatial receive (Rx) parameter. The UE 102b may use a same spatial transmission filter to indicate the spatial relation as used to receive the downlink reference signal from the base stations 104a-104b or transmit the uplink reference signal. The transmitted TCI update signaling updates the TCI state for the channels of a component carrier (CC) that share the TCI state indicted in the TCI update signaling. The CC might be associated with a cell included in a cell list. The cell list is configured via RRC signaling, which may indicate parameters such as a simultaneousTCI-UpdateList1 parameter, a simultaneousTCI-UpdateList2 parameter, a simultaneousTCI-UpdateList3 parameter, or a simultaneousTCI-UpdateList4 parameter.

Signaling communicated between the base stations 104a-104b and the UE 102b may be dedicated signaling or non-dedicated signaling. “Dedicated signaling” refers to signaling between the base stations 104a-104b and the UE 102b that is UE-specific. For example, dedicated signaling may correspond to a physical downlink control channel (PDCCH), a PDSCH, a physical uplink control channel (PUCCH), or a physical uplink shared channel (PUSCH) associated with the cell list that shares the indicated TCI state. PUSCH/PUCCH triggered at the UE 102b by the DCI, activated based on the MAC-CE, or configured based on an uplink grant in RRC signaling from the base stations 104a-104b are dedicated signals.

“Non-dedicated signaling” refers to signaling between the base stations 104a-104b and a non-specific UE. For example, non-dedicated signaling may correspond to physical broadcast channel (PBCH), PDCCH/PDSCH transmissions from the base stations 104a-104b for non-specific UEs, aperiodic CSI-RS, or SRS for codebook, non-codebook, or antenna switching. PDCCH in a control resource set (CORESET) associated with Types 0/0A/0B/1/2 common search spaces, and PDSCH scheduled by such PDCCH are non-dedicated signals. However, other PDCCH and PDSCH signaling may be dedicated signals. The search space type might be defined based on standardized protocols.

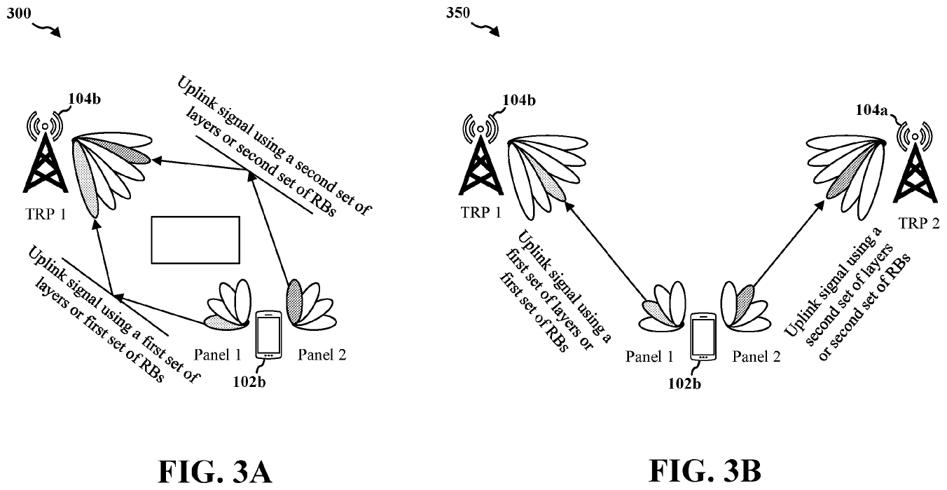

FIGS. 2A-2B describe simultaneous reception by a UE 102b on downlink resources, whereas FIGS. 3A-3B describe simultaneous transmission by the UE 102b on uplink resources.

FIGS. 3A-3B illustrate diagrams 300-350 for STxMP of a UE 102b to one or more TRPs (e.g., one or more base stations 104a-104b). The UE 102b can include a plurality of transmission panels, from which the one or more TRPs/base stations 104a-104b can schedule the UE 102b to simultaneously transmit a plurality of uplink beams. For example, the base station 104b can schedule the UE 102b to transmit two uplink beams from different transmission panels of the UE 102b, such that the UE 102b may transmit a first uplink signal to the base station 104b using a first set of layers or a first set of resource blocks (RBs) and simultaneously transmit a second uplink signal to the same base station 104b using a second set of layers or a second set of RBs, as illustrated in the diagram 300. In examples, the uplink beams/signals may be reflected around an object prior to being received by the base station 104b. Alternatively, a plurality of base stations 104a-104b can schedule the UE 102b to transmit the two uplink beams from the different transmission panels of the UE 102b, such that the UE 102b may transmit a first uplink signal to a first base station 104b using a first set of layers or a first set of RBs and simultaneously transmit a second uplink signal to a second base station 104a using a second set of layers or a second set of RBs, as illustrated in the diagram 350.

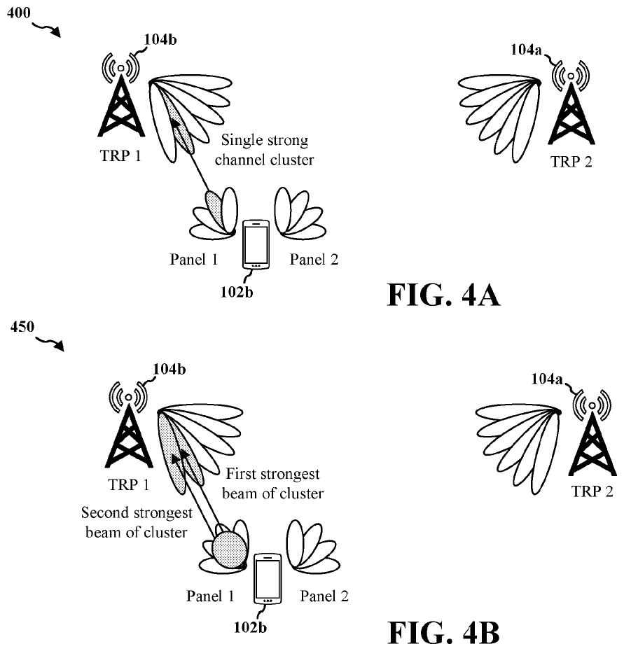

Uplink signals that the UE 102b simultaneously transmits to the one or more base stations 104a-104b with different beams/panels may be multiplexed based on spatial domain multiplexing (SDM) or frequency domain multiplexing (FDM). A network may receive the uplink signals associated with the different beams/panels via one TRP (e.g., base station 104b) or multiple TRPs (e.g., base stations 104a-104b), as illustrated in the diagrams 300-350. The one or more base stations 104a-104b may indicate two TCI states to the UE 102b and schedule STxMP based on SDM techniques. For example, the two TCI states can be applied to different demodulation reference signal (DMRS) ports and different layers. In other examples, the one or more base stations 104a-104b may indicate the two TCI states to the UE 102b and schedule STxMP based on FDM techniques, where the two TCI states can be applied to different sets of RBs. Whiles FIGS. 2A-2B and 3A-3B illustrate STxMP of the UE 102b with antenna reciprocity, FIGS. 4A-4B illustrate one or more transmissions from a single panel of the UE 102b.

FIGS. 4A-4B illustrate uplink transmission(s) based on one or more strongest beams from a same panel of the UE 102b. Although the UE 102b can include multiple uplink transmission panels, repeatedly activating the multiple uplink transmission panels for STxMP might increase a power consumption at the UE 102b. In some cases, the UE 102b might not receive a significant communications benefit from having the multiple uplink panels activated simultaneously. For example, if the UE 102b is near a cell center with a single strong channel cluster associated with a first base station 104b, as illustrated in the diagram 400, uplink beams of the UE 102b might not have sufficient signal strength with a different channel cluster associated with a second base station 104a that is farther away from the UE 102b. Thus, in this example, any throughput benefit to communicating with the second base station 104a is marginal and insufficient to justify activating the second panel.

In further examples, if the multiple uplink beams (e.g., first/second strongest beams) have sufficient signal strength with a same channel cluster of the first base station 104b, as illustrated in the diagram 450, the multiple uplink beams might be associated with a same physical uplink transmission panel at the UE 102b, rather than different physical uplink transmission panels for each beam. Thus, activating the multiple panels might cause a power efficiency degradation at the UE 102b, as a second panel at the UE 102b might not be used for the uplink transmissions. Repeatedly activating and deactivating the multiple physical uplink panels at the UE 102b might also cause the panels to overheat and degrade the performance of the UE 102b.

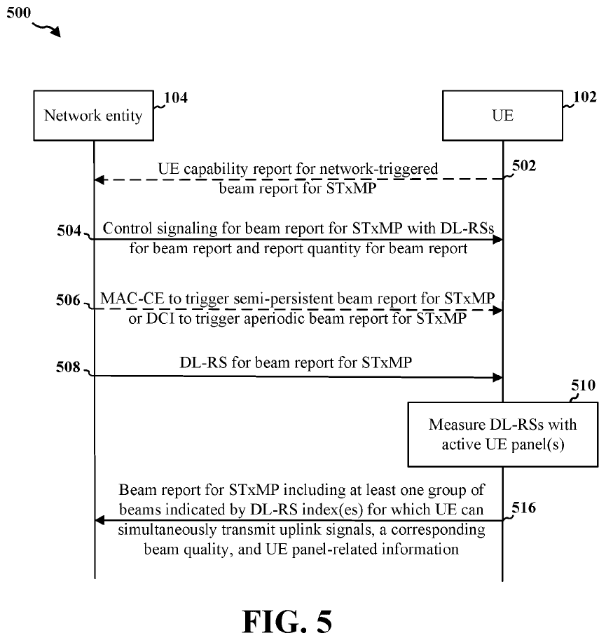

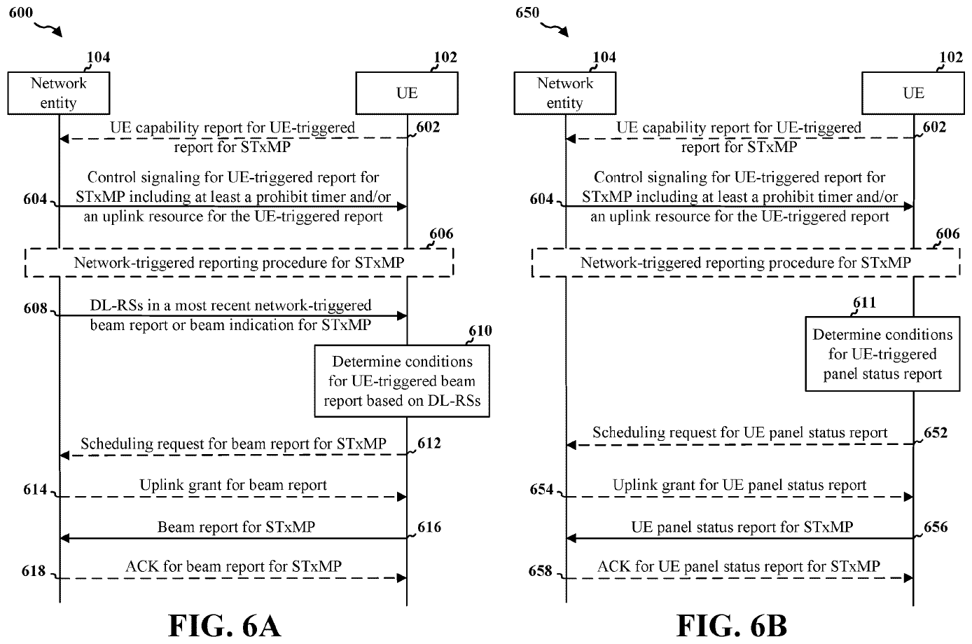

The one or more base stations 104a-104b might have to be aware of a panel status change at the UE 102b (e.g., activation/deactivation), because the panel status change might impact a TCI state assignment from the base station (e.g., the UE 102b cannot transmit two beams simultaneously if only one panel is active) and/or a precoder selection (e.g., the UE 102b cannot transmit uplink signals from a greater number of layers than associated with the activated panel(s)). While the one or more base stations 104a-104b might trigger a beam report without receiving panel information from the UE 102b, the trigger might not be appropriately timed for STxMP. For example, without panel status information, the one or more base stations 104a-104b might not have information to configure appropriate timing (e.g., based on UE panel status changes) for a beam report periodicity and slot offset for the beam report. Accordingly, UE-triggered and/or network-triggered beam reports of UE panel information and/or control signaling for indicating a downlink precoder associated with panel status changes at the UE 102b might improve STxMP techniques. FIGS. 2A-4B illustrate physical transmissions from one or more panels of the UE 102b, with FIG. 4 focusing on situations where simultaneous multi-panel transmissions might be problematic. FIGS. 5 and 6A-6B illustrate reporting procedures for the physical transmissions to support a UE reporting the various types of situations in a timely manner.

FIG. 5 is a signaling diagram 500 for a network-triggered beam report for STxMP. In some examples, the UE 102 may transmit 502 a UE capability report indicative of a UE capability for generating/transmitting a network-triggered beam report for STxMP to the network entity 104. The one or more UE capabilities might correspond to a first maximum number of SSB/CSI-RS resources configured for the STxMP beam report, a second maximum number of SSB/CSI-RS resources in a slot for the beam report for STxMP, a third maximum number of active transmit (Tx) panels at the UE 102, and a number of antenna ports for each Tx panel. The one or more UE capabilities may be counted per CC, per band, per band combination, or per UE. The one or more UE capabilities may be reported/transmitted 502 per feature set, per band, per band combination, or per UE. The network entity 104 may receive the one or more UE capabilities in the UE capability report or from a core network entity, such as an AMF. In another example, the network entity 104 may receive the one or more UE capabilities from a second non-core network entity, such as a second base station via a backhaul link.

The network entity 104 may transmit 504 control signaling to the UE 102 for the beam report for STxMP, where the beam report may be based on a measurement at the UE 102 of one or more downlink reference signals and indicate a reporting quantity of uplink beams used for STxMP. Alternatively, the network entity 104 may transmit 504 the control signaling to the UE 102 via a non-core network entity, such as a base station via a backhaul link. An uplink panel or a UE Tx panel, as used herein, refers to a UE antenna panel used for uplink transmissions. One or more transmission-related components (e.g., a power amplifier) associated with the uplink panels may be used to switch the uplink panels on/off. In some implementations, the UE 102 may receive downlink signaling in the panel, while in other implementations the UE 102 may not receive the downlink signaling in the panel.

The network entity 104 may configure one or more parameters for the beam report for STxMP via RRC signaling (e.g., via a CSI-ReportConfig). The RRC signaling may indicate an RRC reconfiguration message from the network entity 104 to the UE 102, or a system information block (SIB) transmitted from the network entity 104 to the UE 102, where the SIB can be a predefined SIB (e.g., SIBI) or a different SIB (e.g., SIB J, where J corresponds to an integer greater than 21). The network entity 104 may configure, in a report configuration (e.g. CSI-ReportConfig), S (e.g., S=2) sets of downlink reference signals (e.g., SSB/CSI-RS) for the beam report for STxMP, uplink resources for the beam report, a number of reported beam groups, and/or the report quantity of uplink beams for STxMP. In some implementations, the network entity 104 transmits the RRC reconfiguration message to the UE 102 via a signaling radio bearer (SRB) (e. g, SRBI). In other implementations, the network entity 104 transmits the RRC reconfiguration message to the UE 102 via a non-core network entity, such as a base station via a backhaul link.

The RRC signaling may indicate one or more of a flag that enables the beam report for STxMP (e.g. type2-groupBasedBeamReporting), S (e.g., S=2) sets of SSB/CSI-RS resources for the beam report for STxMP, up to S (e.g., S=2) sets of interference measurement resources (IMRs), a number of reported beam groups, or the report quantity associated with the beams for STxMP, which might cause the UE 102 to report the Tx panel information in addition to a beam index and/or a beam quality (e.g. L1-RSRP or L1-SINR). Other RRC parameters can include a nrofReportedGroups used to indicate the number of reported beam groups, a reportQuantity used to indicate the report quantity, a csi-SSB-ResourceSetListExt used to configure a second set of SSBs for channel measurement, a csi-CSI-RS-ResourceSetListExt used to configure a second set of non-zero-power (NZP) IMRs or NZP CSI-RSs for channel measurement, a csi-IM-ResourceSetListExt used to configure a second set of zero-power (ZP) IMRs, and the type2GroupBasedBeamReporting used to enable the beam report for STxMP.

The network entity 104 may transmit 506 a MAC-CE to the UE 102 to trigger a semi-persistent beam report for STxMP or transmit 506 DCI to the UE 102 to trigger an aperiodic beam report for STxMP. In further examples, the UE 102 may transmit a periodic beam report for STxMP based on a periodicity and a slot offset configured by the network entity 104 through the RRC signaling (not shown). After the UE 102 receives 504 the control signaling to configure, and possibly trigger, the beam report for STxMP, or optionally receives 506 the MAC-CE/DCI (or possibly RRC message) to trigger the beam report for STxMP, the UE 102 can receive 508 and measure 510 the one or more downlink reference signals with the active UE panel(s).

The one or more downlink reference signals that the UE 102 receives 508 from the network entity 104 may cause the UE 102 to activate one or more UE panels and determine at least one group of network beams applied to the one or more downlink reference signals that the UE 102 can use for pairing with uplink signal transmissions. The UE 102 may report, using the configured uplink resources, Tx panel information to the network entity 104 for each group of downlink reference signals.

The UE 102 transmits 516 the beam report to the network entity 104 for STxMP including at least one group of beams indicated by downlink reference signal index(es) for which the UE 102 can simultaneously transmit uplink signals, a corresponding beam quality, and UE panel-related information. The UE 102 might report M groups of beams in the beam report transmitted 516 to the network entity 104, where M may be predefined (e.g., M=1) or configured by the network entity 104 through RRC signaling such as the transmitted 504 control signaling. For each group of beams, the UE 102 may report N downlink reference signal indexes (e.g. N SSB resource indicators (SSBRIs) or CSI-RS resource indicators (CRIs)). A value of N might be predefined to correspond to a same value as a number of downlink reference signal sets used for the beam report for STxMP, where each downlink reference signal is selected from a set of downlink reference signals configured by the network entity 104 through the RRC signaling. If CSI-RS resources in a CSI-RS resource set correspond to a same port(s) (e.g., an RRC parameter repetition for a CSI-RS resource set is ‘on’), the UE 102 might not report repeatedly to the network entity 104 the downlink reference signal index for the CSI-RS resource set for CSI-RS based beam reports.

The UE 102 may also report, for each group of beams, the LI-RSRP or the LI-SINR for each downlink reference signal with the reported downlink reference signal index. In further examples, the UE 102 reports UE Tx panel information for the N downlink reference signals within each group of beams. The UE 102 can report whether the N downlink reference signals correspond to a same UE Tx panel or a same UE Tx beam. In other examples, the UE 102 reports, in the beam report transmitted 516 to the network entity 104, a first maximum number of uplink transmission layers, a second maximum number of PUSCH antenna ports for the N downlink reference signals, or a third maximum number of SRS resource sets for simultaneous transmission. If the N downlink reference signals correspond to one UE Tx panel, the UE 102 may report to the network entity 104 that the first maximum number of uplink transmission layers or the second maximum number of PUSCH antenna ports equals 2. If the N downlink reference signals corresponds to NUE Tx panels, the UE 102 may report that the first maximum number of uplink transmission layers or the maximum number of PUSCH antenna ports equals 2N.

The UE 102 may further report, for each group of beams, downlink reference signal resource set indicators to the network entity 104. That is, the UE 102 may indicate the resource set index for a downlink reference signal with a strongest L1-RSRP or strongest L1-SINR. The UE 102 might indicate an absolute L1-RSRP or an absolute L1-SINR for the strongest downlink reference signal. The UE 102 might report a differential L1-RSRP or a differential L1-SINR with the L1-RSRP or the L1-SINR for the reported strongest downlink reference signal as a reference for other reported downlink reference signals. FIG. 5 illustrates a network-triggered reporting procedure for STxMP, whereas FIGS. 6A-6B illustrate UE-triggered reporting procedures for STxMP.

FIGS. 6A-6B are signaling diagrams 600-650 for UE-triggered beam/panel reports for STxMP. In particular, the signaling diagram 600 illustrates a UE-triggered beam report, whereas the signaling diagram 650 illustrates a UE-triggered panel status change/update report (e.g., a report that indicates activated/deactivated panels at the UE 102).

The UE 102 may transmit 602 a UE capability report to the network entity 104 indicative of a UE capability for generating/transmitting the UE-triggered beam/panel report(s) for STxMP to the network entity 104. The one or more UE capabilities might correspond to support for a prohibit timer for transmission of the UE-triggered report, a maximum duration of the prohibit timer (if supported) for the UE-triggered report, a maximum number of downlink reference signals supported for trigger condition detection, a maximum number of reported downlink reference signal groups supported in a UE-triggered aperiodic report, etc. The one or more UE capabilities may be counted per CC, per band, per band combination or per UE. The one or more UE capabilities may be reported/transmitted 602 per feature set, per band, per band combination, or per UE. The one or more UE capabilities may be transmitted to the network entity 104 from various sources as described with respect to transmission 502.

The network entity 104 may transmit 604 control signaling to the UE 102 for the UE-triggered report for STxMP (e.g., beam report in FIG. 6A or UE panel status report in FIG. 6B). For example, the network entity 104 transmits 604 the control signaling to the UE 102 via a SRB (e. g, SRB1). In another example, the network entity 104 transmits 604 the control signaling to the UE 102 via a non-core network entity, such as a base station via a backhaul link. The control signaling transmitted 604 to the UE 102 may indicate at least one of a prohibit timer (activation and duration) and/or an uplink resource for transmitting the UE-triggered report. The network entity 104 may configure a duration of the prohibit timer for the UE-triggered beam/panel report(s) via RRC signaling. The network entity 104 may also configure a dedicated scheduling request for the UE 102 to request 612/652 the uplink resources for transmission 616/656 of the UE-triggered beam/panel report(s) or threshold criterion for the UE 102 to trigger 610/611 aperiodic beam/panel report(s) for STxMP (e.g., based on the support indicating by one or more UE capabilities). If the network entity 104 does not configure the scheduling request, the UE 102 may request 612/652 the uplink resources based on a scheduling request configured for other communications, such as for a contention based random access (CBRA) procedure.

The network entity 104 may configure X dedicated scheduling requests, where each scheduling request corresponds to a serving cell or a serving cell group. A value of X might be a same number as a number of configured serving cells or serving cell groups. The UE 102 may transmit 612/652 a corresponding scheduling request for the serving cell or serving cell group that triggers the beam/panel report(s) from the UE 102. The network entity 104 may configure one scheduling request per UE 102 so that, in the UE-triggered beam/panel report(s), the UE 102 may report the serving cell or serving cell group index to indicate a target serving cell or target serving cell group for the beam/panel report(s).

The UE 102 may start the prohibit timer after the UE 102 receives 604 an initial configuration of the duration of the prohibit timer for the UE-triggered beam/panel report(s). The UE 102 may also start (or restart) the prohibit timer after transmission(s) 616/656 of the UE-triggered beam/panel report(s). As another example, the UE 102 can start/reset the prohibit timer after the UE 102 receives 618/658 an acknowledgement (ACK) from the network entity 104 for the UE-triggered beam/panel report(s).

After receiving 604 the control signaling from the network entity 104, the UE 102 and the network entity 104 may perform 606 a network-triggered reporting procedure for STxMP, such as the network-triggered reporting procedure illustrated in FIG. 5. Referring to the signaling diagram 600, the network entity 104 transmits 608 one or more downlink reference signals indicated by the network entity 104 in previously-transmitted 604 control signaling. The UE 102 can measure the one or more downlink reference signals for trigger condition detection to trigger an aperiodic beam report. In some examples, the one or more downlink reference signals received/measured by the UE 102 may be associated with a most recent TCI indication for the uplink channels for STxMP (e.g., uplink beam indication). If the UE 102 determines 610 that conditions are met for the UE-triggered beam report based on the one or more downlink reference signals received 608 from the network entity 104, the UE 102 may transmit 612 the scheduling request to the network entity 104 for the beam report for STxMP. Based on receiving 614, from the network entity 104, an uplink grant for the beam report, the UE 102 transmits 616 the beam report for STxMP to the network entity 104.

The UE 102 may also be configured to transmit 616 the UE-triggered beam report after the prohibit timer expires. In further examples, the UE 102 may transmit 616 the UE-triggered beam report in cases where the UE 102 determines to switch off/deactivate one of the Tx active panels. This may occur as a result of overheating or power saving at the UE 102. The UE 102 is also able to switch on/activate at least one inactive Tx panel to improve uplink performance, which might also trigger a UE-triggered beam report. The beam quality (e.g., L1-RSRP or L1-SINR) for a UE panel that corresponds to at least one of the downlink reference signals might be smaller than a threshold, where the threshold can be predefined or configured based on RRC signaling. A minimum, average, or maximum beam quality (e.g., L1-RSRP or L1-SINR) for the downlink reference signals within a group measured via different UE Tx panels might be larger than a minimum, average, or maximum beam quality in the most recent beam report plus a first offset, where the first offset can be predefined or configured based on RRC signaling. The downlink reference signals received 608 at the UE 102 may correspond to either the most recent beam report for STxMP or the most recent TCI indication for the uplink channels for STxMP. After transmitting 616 the beam report for STxMP, the UE 102 may receive 618 an ACK for the beam report for STxMP in acknowledgment/negative acknowledgment (ACK/NACK) feedback from the network entity 104.

Referring to the signaling diagram 650, after the UE 102 receives 604 the control signaling from the network entity 104 and optionally performs 606 the network-triggered reporting procedure for STxMP with the network entity 104, the UE 102 might determine 611 that conditions are met for a UE-triggered panel status report (e.g., based on a change to an activation/deactivation status of at least one UE Tx panel as described previously). For example, if the UE 102 determines 611 that a trigger condition for a Tx panel status update/change is true, the UE 102 may transmit 652 the scheduling request for the UE-triggered panel status report to the network entity 104. The UE 102 may receive 654 an uplink grant for the UE panel status report based on the scheduling request transmitted 652 to the network entity 104, such that the UE 102 may transmit 656 the UE-triggered panel status report for STxMP to the network entity 104. After transmitting 656 the UE panel status report for STxMP, the UE 102 may receive 658 an ACK for the UE panel status report for STxMP in ACK/NACK feedback from the network entity 104.

The UE 102 might transmit 656 the UE-triggered panel status report to the network entity 104 as uplink control information (UCI) in a PUCCH or in a PUSCH transmission. For example, the UE 102 might transmit 656 the UE-triggered panel status report when the prohibit timer expires. In further examples, the UE 102 may transmit 656 the UE-triggered panel status report as a result of overheating or power saving at the UE 102 in cases where the UE 102 determines to switch off/deactivate one of the Tx active panels. The UE 102 is also able to switch on/activate at least one inactive Tx panel to improve uplink performance, which might also trigger a UE-triggered panel status report. The UE 102 might apply the reported UE Tx panel status change to multiple beam groups. For example, the UE might deactivate at least one uplink panel for the UE power savings and report the updated/changed number of active panels to the network entity 104. After receiving 656 the UE panel status report, the network entity 104 may transmit control signaling to update the uplink configurations.

The UE 102 can transmit 656 an aperiodic panel status report including the updated/changed UE Tx panel status information. For example, the UE 102 might transmit 656 the UE-triggered panel status report via MAC-CE. If an uplink grant is not received for the UE panel status report, the UE 102 can transmit a scheduling request to the network entity 102 to request uplink resources for a MAC-CE based UE panel status report for STxMP.

Referring again to both the signaling diagrams 600-650, a MAC-CE transmission might include the beam report for STxMP, the UE panel status report for STxMP, or updated/changed UE Tx panel information. The UE 102 may transmit 616/656 the UE-triggered beam/panel report(s) for STxMP by MAC-CE. The MAC-CE may indicate a serving cell index to which the beam report corresponds, downlink reference signal indexes/group indexes, or TCI state indexes that may be used to indicate the beam group associated with the UE Tx panel status change. The MAC-CE may also indicate a maximum number of uplink layers, a maximum number of PUSCH antenna ports, a maximum number of SRS resource sets for simultaneous transmission, or whether the downlink reference signals are transmitted 608 from the same Tx beam/panel for each reported group of downlink reference signals used to indicate the updated/changed UE Tx panel status for each beam group. In further examples, the UE 102 transmits 656 the UE-triggered panel status report for STxMP by MAC-CE to indicate a serving cell index or serving cell group index for the UE panel status report.

The UE 102 may transmit 656 the UE-triggered panel status report for STxMP via RRC message (e.g., a UEAssistanceInformation message). For example, the UE 102 may report a reduced number of active Tx panels in the RRC message transmitted to the network entity 104. The reduced number of active Tx panels may be indicated by a reduced maximum number of uplink antenna ports or a reduced maximum number of SRS resource sets for simultaneous transmission. The maximum number of uplink antenna ports can be indicated based on a reducedMaxNrofPorts-FR2-UL parameter or a MaxNrofPorts-Preference-FR2-UL parameter, where the UE 102 can report “port1” or “ports2”, if the UE 102 supports and determines to use 1 active Tx panel, and can report “ports3” or “ports4”, if the UE supports and determines to use 2 active Tx panels. The candidate value “portsX” indicates the X ports. In further examples, the maximum number of uplink antenna ports can be indicated based on a reducedMaxNrofSrsSets-STxMP-FR2-UL parameter or a MaxNrofSrsSets-STxMP-Preference-FR2-UL parameter, where the UE 102 can report “set1”, if the UE 102 supports and determines to use 1 active Tx panel, and can report “sets2”, if the UE 102 supports and determines to use 2 active Tx panels. The candidate value “sets Y” indicates the Y sets.

For UE-triggered beam/panel reports transmitted 616/656 via UCI on PUCCH or on PUSCH, the network entity 104 may transmit 618/658 the ACK to the UE 102 via DCI in a dedicated search space or CORESET configured by the network entity 104 through RRC signaling. Alternatively, the network entity 104 may transmit 618/658 the ACK via DCI associated with a dedicated radio network temporary identifier (RNTI), which the network entity 104 can configure through the RRC signaling. For MAC-CE based UE-triggered beam/panel reports, the network entity 104 may transmit 618/658 the ACK based on a DCI that schedules a transmission for the PUSCH with a same hybrid automatic repeat request (HARQ) process as used for a previous PUSCH with the MAC-CE for the UE-triggered beam/panel report.

If the UE-triggered beam/panel report indicates that uplink transmission from a particular panel is switched off/deactivated, the network entity 104 refrains from transmitting a DCI to the UE 102 that schedules the UE 102 to transmit and/or receive using the switched off/deactivated panel. If the UE-triggered beam/panel report indicates that uplink transmission from a particular panel is switched on/activated, the network entity 104 can transmit the DCI to the UE 102 that schedules the UE 102 to transmit and/or receive using the switched on/activated panel. Similarly, if the UE-triggered beam/panel report indicates that downlink reception for a particular panel is switched off/deactivated, the network entity 104 refrains from transmitting a DCI to the UE 102 that schedules the UE 102 to receive downlink signaling using the switched off/deactivated panel. If the UE-triggered beam/panel report indicates that downlink reception for a particular panel is switched on/activated, the network entity 104 can transmit the DCI to the UE 102 that schedules the UE 102 to receive downlink signaling using the switched on/activated panel.

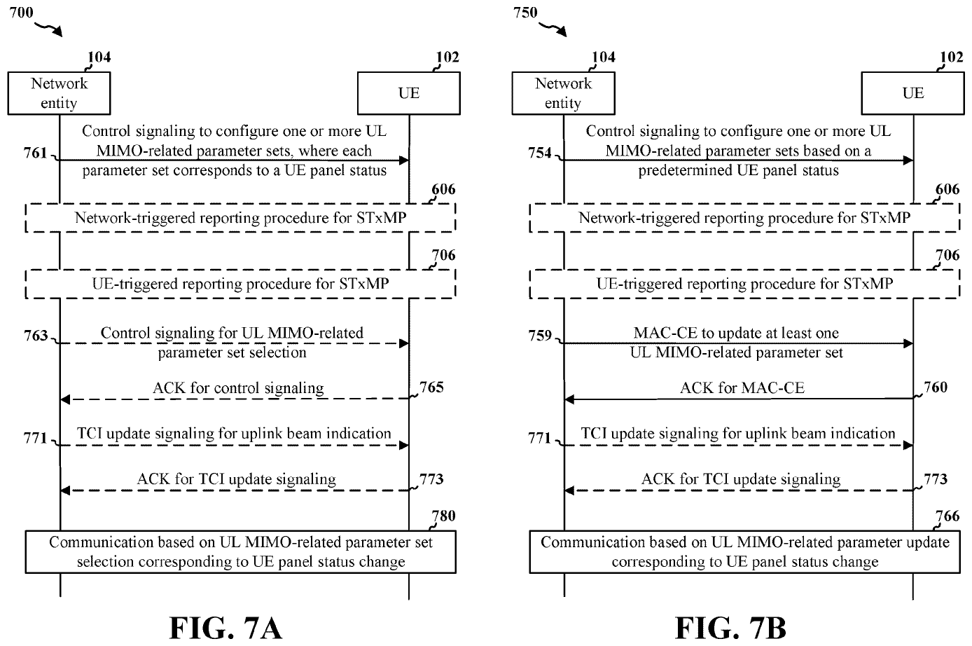

If the network entity 104 (e.g., base station) includes a CU and a DU, the CU might receive a packet data convergence protocol (PDCP) protocol data unit (PDU) including the UE-triggered beam/panel report from the UE via the DU. As such, the CU retrieves the UE-triggered beam/panel report from the PDCP PDU and transmits the UE-triggered beam/panel report to the DU. The DU may or may not refrain from transmitting a DCI to the UE 102 based on the activation/deactivation status of the UE panels. FIGS. 6A-6B illustrate beam reporting and UE panel status reporting for STxMP. FIGS. 7A-7B illustrate communication procedures for STxMP after a change to a UE panel status.

FIGS. 7A-7B are signaling diagrams 700-750 that illustrate procedures for communicating 780/766 based on uplink MIMO parameters after a UE panel status change (e.g., as reported 656 in FIG. 6B). The signaling diagram 700 corresponds to a procedure for uplink MIMO parameter set selection based on the UE panel status change. The network entity 104 can transmit 761 control signaling to the UE 102 to configure one or more uplink MIMO-related parameter sets, where each parameter set might correspond to the UE panel status (e.g., 1 active Tx panel, 2 active Tx panels, etc.). For example, the network entity 104 transmits 761 the control signaling to the UE 102 via a SRB (e.g. SRB1). In another example, the network entity 104 transmits 761 the control signaling to the UE 102 via a non-core network entity, such as a base station via a backhaul link. After the network entity 104 and the UE 102 optionally perform 606/706 the network-triggered reporting procedure for STxMP and/or the UE-triggered reporting procedure for STxMP reflected in FIGS. 6A-6B, the network entity 104 may transmit 763 control signaling (e.g., MAC-CE or DCI) to the UE 102 for uplink MIMO-related parameter set selection to configure further communication 780 with the UE 102.

A default parameter set might be utilized (e.g., first parameter set) by the UE 102 and the network entity 104 prior to the network entity 104 transmitting 763 the control signaling to the UE 102 for the uplink MIMO parameter set selection. After the UE 102 receives 763 the control signaling for the uplink MIMO parameter set selection, the UE 102 might transmit 765 an ACK to the network entity 104 in ACK/NACK feedback for the control signaling.

The network entity 104 may transmit 771 TCI update signaling for uplink beam indication based on a most recent beam report for STxMP. In some examples, the network entity 104 and the UE 102 may automatically update/change the uplink MIMO parameters based on the most recent beam report without control signaling, where the network entity 104 and the UE 102 may apply the uplink MIMO parameter set corresponding to the most recently reported UE Tx panel status. After the UE 102 receives 771 the TCI update signaling for the uplink beam indication, the UE 102 might transmit 773 an ACK to the network entity 104 in ACK/NACK feedback for the TCI update signaling. The network entity 104 and the UE 102 may communicate 780 based on the uplink MIMO-related parameter set selection corresponding to the UE panel status change.

The signaling diagram 750 corresponds to a procedure for an uplink MIMO parameter update based on the UE panel status change. The network entity 104 can transmit 754 control signaling to the UE 102 to configure one or more uplink MIMO-related parameter sets based on a predetermined UE panel status (e.g., 1 active Tx panel, 2 active Tx panels, etc.). For example, the network entity 104 transmits 754 the control signaling to the UE 102 via a SRB (e. g, SRB1). In another example, the network entity 104 transmits 754 the control signaling to the UE 102 via a non-core network entity, such as a base station via a backhaul link. In examples, the network entity 104 might configure a set of uplink MIMO parameters through RRC signaling. For instance, each parameter set (e.g., in a PUSCH-Config) may be indicative of a codebook subset configuration (e.g., codebookSubset and codebookSubsetDCI-0-2) associated with a codebook subset for uplink codebook-based transmissions, a maximum number of uplink layers (e.g., maxRank and maxRankDCI-0-2), and an uplink full power mode (e.g., ul-FullPowerTransmission) that may be used to select the uplink full power transmission mode for a PUSCH transmission. The network entity 104 may configure a list of PUSCH configurations (e.g., PUSCH-Config) and/or SRS configurations (e.g., SRS-Config), where each PUSCH/SRS configuration corresponds to a UE Tx panel status (e.g., 1 active Tx panel or 2 active Tx panels).

After the network entity 104 and the UE 102 optionally perform 606/706 the network-triggered reporting procedure for STxMP and/or the UE-triggered reporting procedure for STxMP reflected in FIGS. 6A-6B, the network entity 104 may transmit 759 a MAC-CE to the UE 102 to update at least one uplink MIMO-related parameter set. For example, the network entity 104 may use the MAC-CE to update uplink MIMO parameters based on a most recently-received beam/panel report for STxMP. The UE 102 can transmit 760 an ACK to the network entity 104 in ACK/NACK feedback for the MAC-CE, such that the UE 102 and the network entity 104 can start to communicate 766 based on the uplink MIMO-related parameter update corresponding to the UE panel status change. In further examples, the communication 766 may be based on transmission 771 of the TCI updating signaling from the network entity 104 and reception 773 of the ACK for the TCI update signaling by the network entity 104, as described with respect to the signaling diagram 700.

The network entity 104 and the UE 102 may apply the uplink MIMO parameter set corresponding to the UE Tx panel status after Y slots from the beam/panel report procedure for the beams associated with the indicated TCI states for the uplink channels, where Y may be predefined, configured by the network entity 104 through RRC signaling, or reported by the UE 102 as a UE capability. The network entity 104 may further transmit 759 a MAC-CE to reduce one or more of the configured uplink MIMO parameter sets. For example, the network entity 104 may configure at least one of a serving cell index, a serving cell list index, an uplink bandwidth part (BWP) index, or parameter set index via the MAC-CE. The network entity 104 and the UE 102 may apply the indicated uplink MIMO parameters set after Z1 slots from transmission 760 of the ACK for the MAC-CE to the network entity 104, where Z1may be predefined, configured by the network entity 104 through RRC signaling, or reported by the UE 102 as a UE capability.

The network entity 104 can also transmit a DCI (not shown) to reduce one or more of the configured uplink MIMO parameter sets. A field of the DCI may be used to indicate a parameter set index. The DCI might be a DCI that schedules a PDSCH transmission, where the network entity 104 determines that the DCI is received by the UE 102 after the network entity 104 receives an ACK for the PDSCH reported by the UE 102. In further examples, the DCI might be a DCI that schedules the PUSCH transmission, where the network entity 104 determines that the DCI is received by the UE 102 after the network entity 104 receives the scheduled PUSCH transmission from the UE 102. In still further examples, the DCI might be a DCI that does not schedule a PDSCH or a PUSCH transmission, but the UE 102 transmits an ACK to the network entity 104 on PUCCH resources after the UE 102 decodes the DCI.

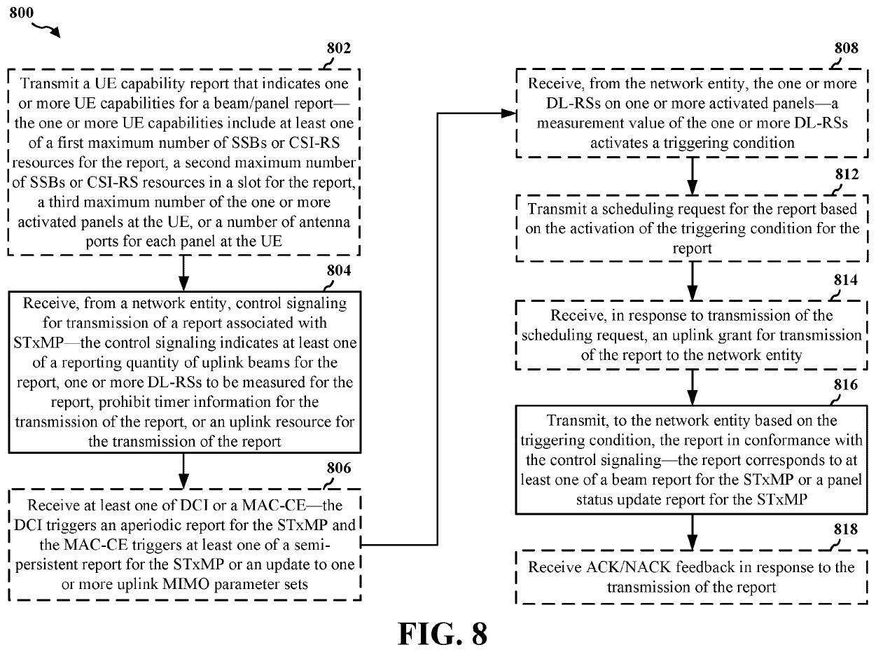

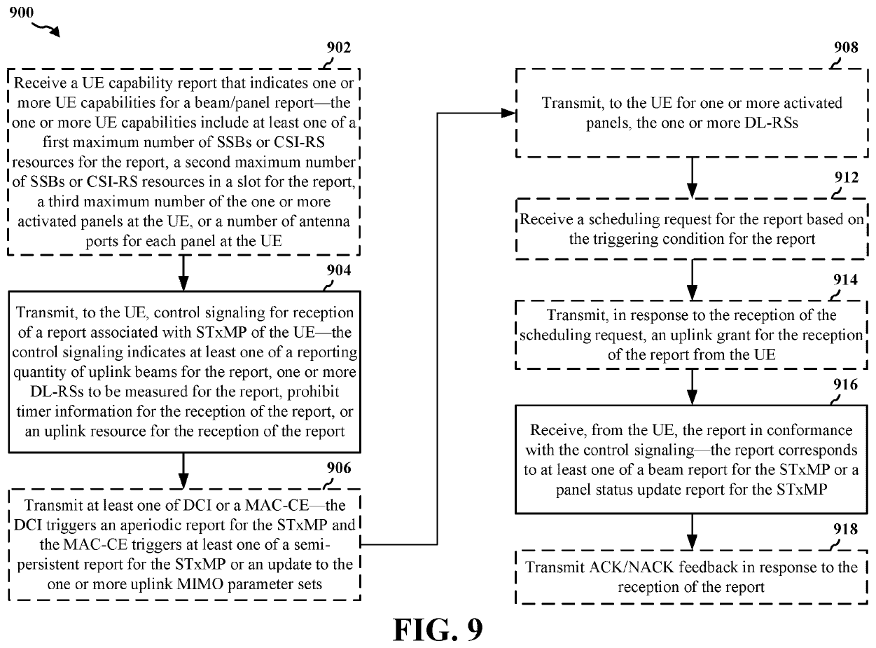

The network entity 104 and the UE 102 might apply the indicated uplink MIMO parameter sets after Z2 slots from transmission 760 of the ACK for the MAC-CE, where Z2 may be predefined, configured by the network entity 104 through RRC signaling, or reported by the UE 102 as a UE capability. In further examples, the network entity 104 might configure a set of uplink MIMO parameters through RRC signaling, and transmit 759 a MAC-CE to update the parameters. For instance, the network entity 104 may configure, via the MAC-CE, a codebook subset (e.g., codebookSubset and codebookSubsetDCI-0-2) that indicates the codebook subset for uplink codebook-based transmission, a maximum number of uplink layers (e.g., maxRank and maxRankDCI-0-2), an uplink full power mode (e.g., ul-FullPowerTransmission) used to select the uplink full power transmission mode for a PUSCH transmission, and/or a serving cell or serving cell list index. FIGS. 5-7B illustrate network-triggered and UE-triggered reports for STxMP. FIGS. 8-9 show methods for implementing one or more aspects of FIGS. 5-7B. In particular, FIG. 8 shows an implementation by the UE 102 of the one or more aspects of FIGS. 5-7B. FIG. 9 shows an implementation by the network entity 104 of the one or more aspects of FIGS. 5-7B.

FIG. 8 illustrates a flowchart 800 of a method of wireless communication at a UE 102. With reference to FIGS. 1-7B and 10, the method may be performed by the UE 102, the UE apparatus 1002, etc., which may include the memory 1024′ and which may correspond to the entire UE 102 or the UE apparatus 1002, or a component of the UE 102 or the UE apparatus 1002, such as the wireless baseband processor 1024, and/or the application processor 1006.

The UE 102 may transmit 802 a UE capability report that indicates one or more UE capabilities for a beam/panel report—the one or more UE capabilities include at least one of a first maximum number of SSBs or CSI-RS resources for the report, a second maximum number of SSBs or CSI-RS resources in a slot for the report, a third maximum number of the one or more activated panels at the UE, or a number of antenna ports for each panel at the UE. For example, referring to FIG. 5, the UE 102 transmits 502, to the network entity 104, a UE capability report for a network-triggered beam report for STxMP. Referring to FIGS. 6A-6B, the UE 102 transmits 602, to the network entity 104, a UE capability report for a UE-triggered report for STxMP.

The UE 102 receives 804, from a network entity, control signaling for transmission of a report associated with STxMP—the control signaling indicates at least one of a reporting quantity of uplink beams for the report, one or more DL-RSs to be measured for the report, prohibit timer information for the transmission of the report, or an uplink resource for the transmission of the report. For example, referring to FIG. 5, the UE 102 receives 504 control signaling from the network entity 104 for a beam report for STxMP with downlink reference signals for the beam report and report quantity for the beam report. Referring to FIGS. 6A-6B, the UE 102 receives 604 control signaling from the network entity 104 for the UE-triggered report for STxMP including at least one of a prohibit timer and/or an uplink resource for the UE-triggered report.

The UE 102 may receive 806 at least one of DCI or a MAC-CE—the DCI triggers an aperiodic report for STxMP and the MAC-CE triggers at least one of a semi-persistent report for STxMP or an update to one or more uplink MIMO parameter sets. For example, referring to FIG. 5, the UE 102 receives 506, from the network entity 104, a MAC-CE to trigger a semi-persistent beam report for STxMP or DCI to trigger an aperiodic beam report for STxMP.

The UE 102 may receive 808, from the network entity, the one or more DL-RSs on one or more activated panels—a measurement value of the one or more DL-RSs activates a triggering condition. For example, referring to FIG. 5, the UE 102 receives 508 one or more downlink reference signals from the network entity 104 for the beam report for STxMP. Referring to FIG. 6A, the UE 102 may receive 608, from the network entity 104, one or more downlink reference signals of a most recent network-triggered beam report or beam indication for STxMP.

The UE 102 may transmit 812 a scheduling request for the report based on the activation of the triggering condition for the report. For example, referring to FIG. 6A, the UE 102 transmits 612 a scheduling request to the network entity 104 for a beam report for STxMP. Referring to FIG. 6B, the UE 102 may transmit 652 a scheduling request to the network entity 104 for a UE panel status report for STxMP.

The UE 102 may receive 814, in response to transmission of the scheduling request, an uplink grant for transmission of the report to the network entity. For example, referring to FIG. 6A, the UE 102 receives 614 an uplink grant from the network entity 104 for the beam report for STxMP. Referring to FIG. 6B, the UE 102 receives 654 an uplink grant from the network entity 104 for the UE panel status report for STxMP.

The UE 102 transmits 816, to the network entity based on the triggering condition, the report in conformance with the control signaling—the report corresponds to at least one of a beam report for STxMP or a panel status update report for STxMP. For example, referring to FIG. 5, the UE 102 transmits 516, to the network entity 104, the beam report for STxMP including at least one group of beams indicated by downlink reference signal index(es) for which the UE 102 can simultaneously transmit uplink signals, a corresponding beam quality, and UE panel-related information. Referring to FIG. 6A, the UE 102 transmits 616 the beam report for STxMP to the network entity 104. Referring to FIG. 6B, the UE 102 transmits 656 the UE panel status report for STxMP to the network entity 104.

The UE 102 may receive 818 ACK/NACK feedback in response to the transmission of the report. For example, referring to FIG. 6A, the UE 102 receives 618 an ACK from the network entity 104 for the beam report for STxMP. Referring to FIG. 6B, the UE 102 receives 658 an ACK from the network entity 104 for the UE panel status report for STxMP. FIG. 8 describes a method from a UE-side of a wireless communication link, whereas FIG. 9 describes a method from a network-side of the wireless communication link.

FIG. 9 is a flowchart 900 of a method of wireless communication at a network entity 104. With reference to FIGS. 1-7B and 11, the method may be performed by one or more network entities 104, which may correspond to a base station or a unit of the base station, such as the RU 106, the DU 108, the CU 110, an RU processor 1142, a DU processor 1132, a CU processor 1112, etc. The one or more network entities 104 may include the memory 1112′/1132′/1142″, which may correspond to an entirety of the one or more network entities 104, or a component of the one or more network entities 104, such as the RU processor 1142, the DU processor 1132, or the CU processor 1112.

The one or more network entities 104 may receive 902 a UE capability report that indicates one or more UE capabilities for a beam/panel report-the one or more UE capabilities include at least one of a first maximum number of SSBs or CSI-RS resources for the report, a second maximum number of SSBs or CSI-RS resources in a slot for the report, a third maximum number of the one or more activated panels at the UE, or a number of antenna ports for each panel at the UE. For example, referring to FIG. 5, the network entity 104 receives 502, the UE 102, a UE capability report for a network-triggered beam report for STxMP. Referring to FIGS. 6A-6B, the network entity 104 receives 602, from the UE 102, a UE capability report for a UE-triggered report for STxMP.

The one or more network entities 104 transmit 904, to the UE, control signaling for reception of a report associated with STxMP of the UE—the control signaling indicates at least one of a reporting quantity of uplink beams for the report, one or more DL-RSs to be measured for the report, prohibit timer information for the reception of the report, or an uplink resource for the reception of the report. For example, referring to FIG. 5, the network entity 104 transmits 504 control signaling to the UE 102 for a beam report for STxMP with downlink reference signals for the beam report and report quantity for the beam report. Referring to FIGS. 6A-6B, the network entity 104 transmits 604 control signaling to the UE 102 for the UE-triggered report for STxMP including at least one of a prohibit timer and/or an uplink resource for the UE-triggered report.

The one or more network entities 104 may transmit 906 at least one of DCI or a MAC-CE—the DCI triggers an aperiodic report for STxMP and the MAC-CE triggers at least one of a semi-persistent report for STxMP or an update to the one or more uplink MIMO parameter sets. For example, referring to FIG. 5, the network entity 104 transmits 506, to the UE 102, a MAC-CE to trigger a semi-persistent beam report for STxMP or DCI to trigger an aperiodic beam report for STxMP.

The one or more network entities 104 may transmit 908, to the UE for one or more activated panels, the one or more DL-RSs. For example, referring to FIG. 5, the network entity 104 transmits 508 one or more downlink reference signals to the UE 102 for the beam report for STxMP. Referring to FIG. 6A, the network entity 104 transmits 608, to the UE 102, one or more downlink reference signals.

The one or more network entities 104 may receive 912 a scheduling request for the report based on the triggering condition for the report. For example, referring to FIG. 6A, the network entity 104 receives 612 a scheduling request from the UE 102 for a beam report for STxMP. Referring to FIG. 6B, the network entity 104 receives 652 a scheduling request from the UE 102 for a UE panel status report for STxMP.

The one or more network entities 104 may transmit 914, in response to the reception of the scheduling request, an uplink grant for the reception of the report from the UE. For example, referring to FIG. 6A, the network entity 104 transmits 614 an uplink grant to the UE 102 for the beam report for STxMP. Referring to FIG. 6B, the network entity 104 transmits 654 an uplink grant to the UE 102 for the UE panel status report for STxMP.

The one or more network entities 104 receive 916, from the UE, the report in conformance with the control signaling-the report corresponds to at least one of a beam report for STxMP or a panel status update report for STxMP. For example, referring to FIG. 5, the network entity 104 receives 516, from the UE 102, the beam report for STxMP including at least one group of beams indicated by downlink reference signal index(es) for which the UE 102 can simultaneously transmit uplink signals, a corresponding beam quality, and UE panel-related information, Referring to FIG. 6A, the network entity 104 receives 616 the beam report for STxMP from the UE 102. Referring to FIG. 6B, the network entity 104 receives 656 the UE panel status report for STxMP from the UE 102.

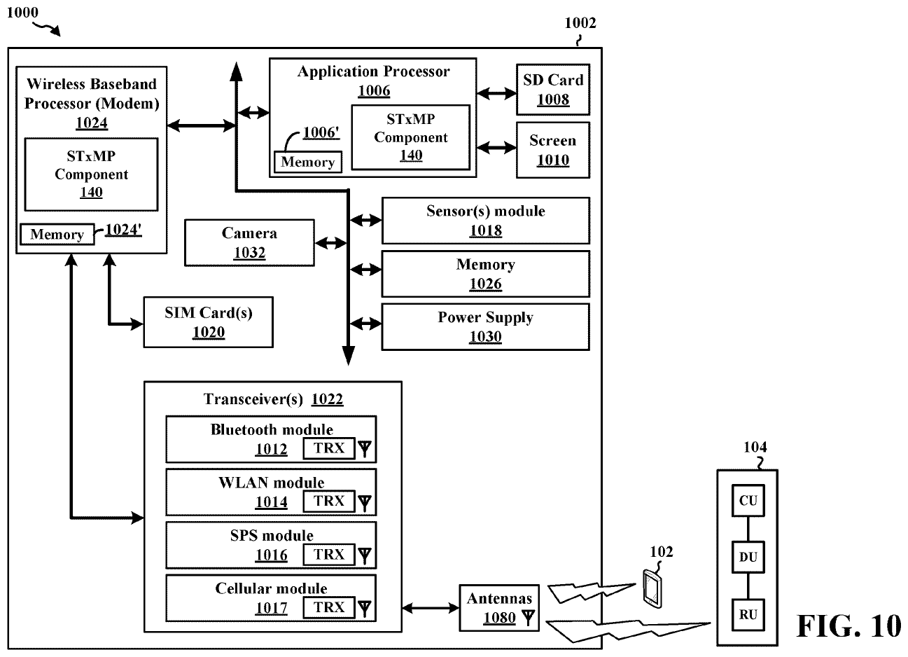

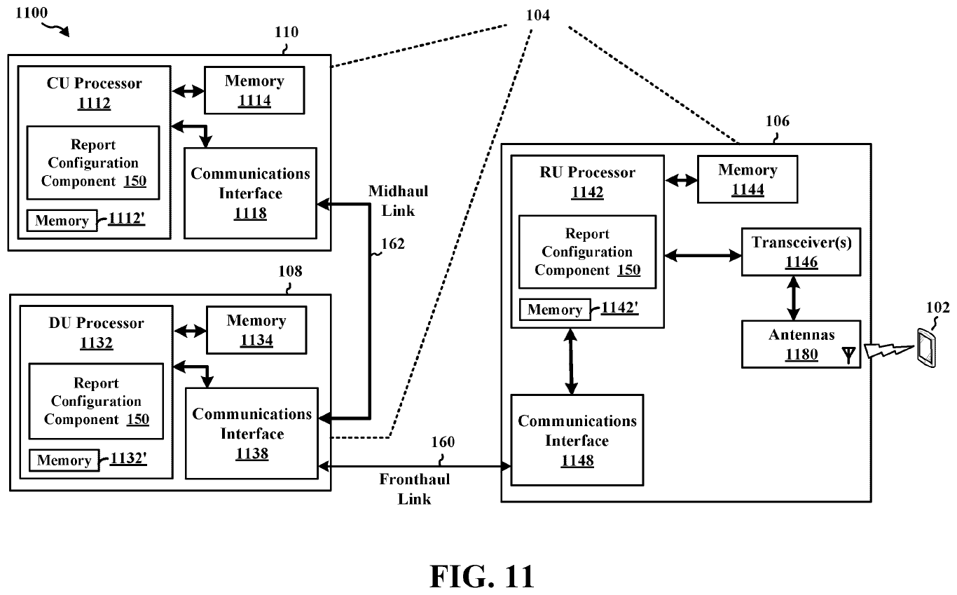

The one or more network entities 104 may transmit 918 ACK/NACK feedback in response to the reception of the report. For example, referring to FIG. 6A, the network entity 104 transmits 618 an ACK to the UE 102 for the beam report for STxMP. Referring to FIG. 6B, the network entity 104 transmits 658 an ACK to the UE 102 for the UE panel status report for STxMP. A UE apparatus 1002, as described in FIG. 10, may perform the method of flowchart 800. The one or more network entities 104, as described in FIG. 11, may perform the method of flowchart 900.

FIG. 10 is a diagram 1000 illustrating an example of a hardware implementation for a UE apparatus 1002. The apparatus 1002 may be the UE 102, a component of the UE, or may implement UE functionality. In some aspects, the apparatus 1002 may include a wireless baseband processor 1024 (also referred to as a modem) coupled to one or more transceivers 1022 (e.g., wireless RF transceiver). The wireless baseband processor 1024 may include on-chip memory 1024′. In some aspects, the apparatus 1002 may further include one or more subscriber identity modules (SIM) cards 1020 and an application processor 1006 coupled to a secure digital (SD) card 1008 and a screen 1010. The application processor 1006 may include on-chip memory 1006′.

The apparatus 1002 may further include a Bluetooth module 1012, a WLAN module 1014, an SPS module 1016 (e.g., GNSS module), and a cellular module 1017 within the one or more transceivers 1022. The Bluetooth module 1012, the WLAN module 1014, the SPS module 1016, and the cellular module 1017 may include an on-chip transceiver (TRX) (or in some cases, just a receiver (RX)). The Bluetooth module 1012, the WLAN module 1014, the SPS module 1016, and the cellular module 1017 may include their own dedicated antennas and/or utilize the antennas 1080 for communication. The apparatus 1002 may further include one or more sensor modules 1018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional modules of memory 1026, a power supply 1030, and/or a camera 1032.

The wireless baseband processor 1024 communicates through the transceiver(s) 1022 via one or more antennas 1080 with another UE 102 and/or with an RU associated with a network entity 104. The wireless baseband processor 1024 and the application processor 1006 may each include a computer-readable medium/memory 1024′, 1006′, respectively. The additional modules of memory 1026 may also be considered a computer-readable medium/memory. Each computer-readable medium/memory 1024′, 1006′, 1026 may be non-transitory. The wireless baseband processor 1024 and the application processor 1006 are each responsible for general processing, including the execution of software stored on the computer-readable medium/memory. The software, when executed by the wireless baseband processor 1024/application processor 1006, causes the wireless baseband processor 1024/application processor 1006 to perform the various functions described. The computer-readable medium/memory may also be used for storing data that is manipulated by the wireless baseband processor 1024/application processor 1006 when executing software. The wireless baseband processor 1024/application processor 1006 may be a component of the UE 102. The apparatus 1002 may be a processor chip (modem and/or application) and include just the wireless baseband processor 1024 and/or the application processor 1006, and in another configuration, the apparatus 1002 may be the entire UE 102 and include the additional modules of the apparatus 1002.

As discussed, the STxMP component 140 is configured to receive, from a network entity, control signaling for transmission of a report associated with STxMP, where the control signaling indicates at least one of a reporting quantity of uplink beams for the report, one or more downlink reference signals to be measured for the report, prohibit timer information for the transmission of the report, or an uplink resource for the transmission of the report; and transmit, to the network entity based on a triggering condition, the report in conformance with the control signaling, where the report corresponds to at least one of a beam report for STxMP or a panel status update report for STxMP. The STxMP component 140 may be within the wireless baseband processor 1024, the application processor 1006, or both the wireless baseband processor 1024 and the application processor 1006. The STxMP component 140 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1002 may include a variety of components configured for various functions. In one configuration, the apparatus 1002, and in particular the wireless baseband processor 1024 and/or the application processor 1006, includes means for receiving, from a network entity, control signaling for transmission of a report associated with STxMP, where the control signaling indicates at least one of a reporting quantity of uplink beams for the report, one or more downlink reference signals to be measured for the report, prohibit timer information for the transmission of the report, or an uplink resource for the transmission of the report; and means for transmitting, to the network entity based on a triggering condition, the report in conformance with the control signaling, where the report corresponds to at least one of a beam report for STxMP or a panel status update report for STxMP. The apparatus 1002 further includes means for receiving, from the network entity, the one or more downlink reference signals on one or more activated panels, where a measurement value of the one or more downlink reference signals activates a triggering condition. The apparatus 1002 further includes means for transmitting a UE capability report that indicates one or more UE capabilities for the report, where the one or more UE capabilities include at least one of a first maximum number of SSBs or CSI-RS resources for the report, a second maximum number of SSBs or CSI-RS resources in a slot for the report, a third maximum number of the one or more activated panels at the UE, or a number of antenna ports for each panel at the UE. The apparatus 1002 further includes means for transmitting a scheduling request for the report based on the activation of the triggering condition for the report; and means for receiving, in response to the transmitting the scheduling request, an uplink grant for the transmitting, to the network entity, the report. The apparatus 1002 further includes means for receiving first ACK/NACK feedback in response to the transmitting the report.

The apparatus 1002 further includes means for receiving at least one of DCI or a MAC-CE, where the DCI triggers an aperiodic beam report for STxMP, and where the MAC-CE triggers at least one of a semi-persistent beam report for STxMP or an update to the one or more uplink MIMO parameter sets. The apparatus 1002 further includes means for transmitting second ACK/NACK feedback responsive to at least one of the control signaling that indicates the one or more uplink MIMO parameter sets or the MAC-CE that updates the one or more uplink MIMO parameter sets. The apparatus 1002 further includes means for receiving a TCI update for an uplink beam indication; and means for transmitting, in response to a decoding operation associated with the receiving the TCI update, third ACK/NACK feedback for the TCI update for the uplink beam indication. The apparatus 1002 further includes means for communicating with the network entity based on a parameter set of the one or more uplink MIMO parameter sets that corresponds to a panel status indicated in the panel status update report. The means may be the STxMP component 140 of the apparatus 1002 configured to perform the functions recited by the means.

FIG. 11 is a diagram 1100 illustrating an example of a hardware implementation for one or more network entities 104. The one or more network entities 104 may be a BS, a component of a BS, or may implement BS functionality. The one or more network entities 104 may include at least one of a CU 1110, a DU 1130, or an RU 1140. For example, the component 199 may sit at the one or more network entities 104, such as the CU 1110; both the CU 1110 and the DU 1130; each of the CU 1110, the DU 1130, and the RU 1140; the DU 1130; both the DU 1130 and the RU 1140; or the RU 1140.

The CU 1110 may include a CU processor 1112. The CU processor 1112 may include on-chip memory 1112′. In some aspects, the CU 1110 may further include additional memory modules 1114 and a communications interface 1118. The CU 1110 communicates with the DU 1130 through a midhaul link 162, such as an F1 interface. The DU 1130 may include a DU processor 1132. The DU processor 1132 may include on-chip memory 1132′. In some aspects, the DU 1130 may further include additional memory modules 1134 and a communications interface 1138. The DU 1130 communicates with the RU 1140 through a fronthaul link 160. The RU 1140 may include an RU processor 1142. The RU processor 1142 may include on-chip memory 1142′. In some aspects, the RU 1140 may further include additional memory modules 1144, one or more transceivers 1146, antennas 1180, and a communications interface 1148. The RU 1140 communicates wirelessly with the UE 102.

The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed, the report configuration component 150 is configured to transmit, to a UE, control signaling for reception of a report associated with STxMP of the UE, where the control signaling indicates at least one of a reporting quantity of uplink beams for the report, one or more downlink reference signals to be measured for the report, prohibit timer information for the reception of the report, or an uplink resource for the reception of the report; and receive, from the UE based on a triggering condition, the report in conformance with the control signaling, where the report corresponds to at least one of a beam report for STxMP or a panel status update report for STxMP. The report configuration component 150 may be within one or more processors of one or more of the CU 1110, DU 1130, and the RU 1140. The report configuration component 150 may be one or more hardware components specifically configured to carry out the stated processes/algorithm, implemented by one or more processors configured to perform the stated processes/algorithm, stored within a computer-readable medium for implementation by one or more processors, or some combination thereof.

The one or more network entities 104 may include a variety of components configured for various functions. In one configuration, the one or more network entities 104 includes means for transmitting, to a UE, control signaling for reception of a report associated with STxMP of the UE, where the control signaling indicates at least one of a reporting quantity of uplink beams for the report, one or more downlink reference signals to be measured for the report, prohibit timer information for the reception of the report, or an uplink resource for the reception of the report; and means for receiving, from the UE based on a triggering condition, the report in conformance with the control signaling, where the report corresponds to at least one of a beam report for STxMP or a panel status update report for STxMP. The one or more network entities 104 further includes means for transmitting, to the UE for one or more activated panels, the one or more downlink reference signals. The one or more network entities 104 further includes means for receiving a UE capability report that indicates one or more UE capabilities for the report, where the one or more UE capabilities include at least one of a first maximum number of SSBs or CSI-RS resources for the report, a second maximum number of SSBs or CSI-RS resources in a slot for the report, a third maximum number of the one or more activated panels at the UE, or a number of antenna ports for each panel at the UE.

The one or more network entities 104 further includes means for receiving a scheduling request for the report; and means for transmitting, in response to the receiving the scheduling request, an uplink grant for the receiving, from the UE, the report. The one or more network entities 104 further includes means for transmitting at least one of DCI or a MAC-CE, where the DCI triggers an aperiodic beam report for STxMP, and where the MAC-CE triggers at least one of a semi-persistent beam report for STxMP or an update to the one or more uplink MIMO parameter sets. The one or more network entities 104 further includes means for receiving second ACK/NACK feedback responsive to at least one of the control signaling that indicates the one or more uplink MIMO parameter sets or the MAC-CE that updates the one or more uplink MIMO parameter sets. The one or more network entities 104 further includes means for transmitting a TCI update for an uplink beam indication; and means for receiving, in response to a decoding operation associated with the transmitting the TCI update, third ACK/NACK feedback for the TCI update for the uplink beam indication. The one or more network entities 104 further includes means for communicating with the UE based on a parameter set of the one or more uplink MIMO parameter sets that corresponds to a panel status indicated in the panel status update report. The means may be the report configuration component 150 of the one or more network entities 104 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, control signaling for transmission of a report associated with STxMP, and includes that the control signaling indicates at least one of a reporting quantity of uplink beams for the report, one or more downlink reference signals to be measured for the report, prohibit timer information for the transmission of the report, or an uplink resource for the transmission of the report; and transmitting, to the network entity based on a triggering condition, the report in conformance with the control signaling, and includes that the report corresponds to at least one of a beam report for STxMP or a panel status update report for STxMP.

Example 2 may be combined with example 1 and further includes receiving, from the network entity, the one or more downlink reference signals on one or more activated panels, and includes that a measurement value of the one or more downlink reference signals activates a triggering condition.

Example 3 may be combined with any of examples 1-2 and further includes transmitting a UE capability report that indicates one or more UE capabilities for the report, and includes that the one or more UE capabilities include at least one of a first maximum number of supported SSBs or CSI-RS resources for the report, a second maximum number of supported SSBs or CSI-RS resources in a slot for the report, a third maximum number of the one or more activated panels at the UE, or a number of antenna ports for each activated panel at the UE.

Example 4 may be combined with any of examples 1-3 and further includes transmitting a scheduling request for the report based on an activation of the triggering condition for the report; and receiving, in response to the transmitting the scheduling request, an uplink grant for the transmitting, to the network entity, the report.

Example 5 may be combined with any of examples 1-4 and includes that the beam report for STxMP includes at least one of a beam quality, panel information, or a group of beams associated with STxMP and indicated by one or more indexes for the one or more downlink reference signals.

Example 6 may be combined with any of examples 1-5 and further includes receiving first ACK/NACK feedback in response to the transmitting the report.

Example 7 may be combined with any of examples 1-6 and includes that the control signaling further indicates one or more of uplink MIMO parameter sets, and includes that at least one of a parameter set of the one or more uplink MIMO parameter sets corresponds to a predefined panel status or each of the one or more uplink MIMO parameter sets corresponds to a respective panel status.

Example 8 may be combined with any of examples 1-7 and further includes receiving at least one of DCI or a MAC-CE, and includes that the DCI triggers an aperiodic beam report for STxMP, and includes that the MAC-CE triggers at least one of a semi-persistent beam report for STxMP or an update to the one or more uplink MIMO parameter sets.

Example 9 may be combined with any of examples 1-8 and further includes transmitting second ACK/NACK feedback responsive to at least one of the control signaling that indicates the one or more uplink MIMO parameter sets or the MAC-CE that updates the one or more uplink MIMO parameter sets.

Example 10 may be combined with any of examples 1-9 and further includes receiving a TCI update for an uplink beam indication; and transmitting, in response to a decoding operation associated with the receiving the TCI update, third ACK/NACK feedback for the TCI update for the uplink beam indication.

Example 11 may be combined with any of examples 1-10 and further includes communicating with the network entity based on a parameter set of the one or more uplink MIMO parameter sets that corresponds to a panel status indicated in the panel status update report.

Example 12 is a method of wireless communication at a network entity, including: transmitting, to a UE, control signaling for reception of a report associated with STxMP of the UE, and includes that the control signaling indicates at least one of a reporting quantity of uplink beams for the report, one or more downlink reference signals to be measured for the report, prohibit timer information for the reception of the report, or an uplink resource for the reception of the report; and receiving, from the UE based on a triggering condition, the report in conformance with the control signaling, and includes that the report corresponds to at least one of a beam report for STxMP or a panel status update report for STxMP.

Example 13 may be combined with example 12 and further includes transmitting, to the UE for one or more activated panels, the one or more downlink reference signals.

Example 14 may be combined with any of examples 12-13 and further includes receiving a UE capability report that indicates one or more UE capabilities for the report, and includes that the one or more UE capabilities include at least one of a first maximum number of supported SSBs or CSI-RS resources for the report, a second maximum number of supported SSBs or CSI-RS resources in a slot for the report, a third maximum number of the one or more activated panels at the UE, or a number of antenna ports for each activated panel at the UE.

Example 15 may be combined with any of examples 12-14 and further includes receiving a scheduling request for the report; and transmitting, in response to the receiving the scheduling request, an uplink grant for the receiving, from the UE, the report.

Example 16 may be combined with any of examples 12-15 and includes that the beam report for STxMP includes at least one of a beam quality, panel information, or a group of beams associated with STxMP and indicated by one or more indexes for the one or more downlink reference signals.

Example 17 may be combined with any of examples 12-16 and includes that the control signaling further indicates one or more uplink MIMO parameter sets, and includes that at least one of a parameter set of the one or more uplink MIMO parameter sets corresponds to a predefined panel status or each of the one or more uplink MIMO parameter sets corresponds to a respective panel status.

Example 18 may be combined with any of examples 12-17 and further includes transmitting at least one of DCI or a MAC-CE, and includes that the DCI triggers an aperiodic beam report for STxMP, and includes that the MAC-CE triggers at least one of a semi-persistent beam report for STxMP or an update to the one or more uplink MIMO parameter sets.

Example 19 may be combined with any of examples 12-18 and further includes receiving second ACK/NACK feedback responsive to at least one of the control signaling that indicates the one or more uplink MIMO parameter sets or the MAC-CE that updates the one or more uplink MIMO parameter sets.

Example 20 may be combined with any of examples 12-19 and further includes transmitting a TCI update for an uplink beam indication; and receiving, in response to a decoding operation associated with the transmitting the TCI update, third ACK/NACK feedback for the TCI update for the uplink beam indication.

Example 21 may be combined with any of examples 12-20 and further includes communicating with the UE based on a parameter set of the one or more uplink MIMO parameter sets that corresponds to a panel status indicated in the panel status update report.

Example 22 is an apparatus for wireless communication for implementing a method as in any of examples 1-21.

Example 23 is an apparatus for wireless communication including means for implementing a method as in any of examples 1-21.

Example 24 is a non-transitory computer-readable medium storing computer executable code, the code when executed by at least one processor causes the at least one processor to implement a method as in any of examples 1-21.

1. A method of wireless communication at a user equipment (UE), comprising:
receiving, from a network entity, control signaling for transmission of a report associated with simultaneous transmission from multiple panels (STxMP), the control signaling indicating at least one of: a reporting quantity of uplink beams for the report or a downlink reference signal to be measured for the report; and
transmitting, to the network entity, the report in conformance with the control signaling, the report corresponding to at least one of a beam report for STxMP or a panel status update report for STxMP.

2. The method of claim 1, further comprising:
receiving, from the network entity, the downlink reference signal on an activated panel, wherein a measurement value of the downlink reference signal activates a triggering condition.

3. The method of claim 2, further comprising:
transmitting a UE capability report that indicates UE capabilities for the report, wherein the UE capabilities include at least one of: a first maximum number of supported synchronization signal blocks (SSBs) or channel state information-reference signal (CSI-RS) resources for the report or a second maximum number of supported SSBs or CSI-RS resources in a slot for the report.

4. The method of claim 1, further comprising:
transmitting a scheduling request for the report based on an activation of the triggering condition for the report; and
receiving an uplink grant for the transmitting the report based on the scheduling request.

5. The method of claim 1, wherein the beam report for STxMP includes at least one of: a beam quality, panel information, or a group of beams associated with STxMP indicated by an index for the downlink reference signal.

6. The method of claim 1, further comprising:
receiving first acknowledgment/negative acknowledgment (ACK/NACK) feedback based on the transmitting the report.

7. The method of claim 1, wherein the control signaling indicates one or more of: uplink multiple-input multiple-output (MIMO) parameter sets, wherein at least one of a parameter set of the one or more uplink MIMO parameter sets corresponds to a predefined panel status or each of the one or more uplink MIMO parameter sets corresponds to a respective panel status.

8. The method of claim 1, further comprising:
receiving at least one of: downlink control information (DCI) or a medium access control-control element (MAC-CE), wherein the DCI triggers an aperiodic beam report for STxMP, and wherein the MAC-CE triggers at least one of a semi-persistent beam report for STxMP or an update to the one or more uplink MIMO parameter sets.

9. The method of claim 1, further comprising:
transmitting second ACK/NACK feedback based on at least one of the control signaling indicating the one or more uplink MIMO parameter sets or the MAC-CE updating the one or more uplink MIMO parameter sets.

10. The method of claim 1, further comprising:
receiving a transmission configuration indicator (TCI) update for an uplink beam indication; and
transmitting third ACK/NACK feedback for the TCI update for the uplink beam indication based on a decoding operation associated with the receiving of the TCI update.

11. The method of claim 1, further comprising:
communicating with the network entity based on a parameter set of the one or more uplink MIMO parameter sets that corresponds to a panel status indicated in the panel status update report.

12. A method of wireless communication at a network entity, comprising:
transmitting, to a user equipment (UE), control signaling for reception of a report associated with simultaneous transmission from multiple panels (STxMP) of the UE, the control signaling indicating at least one of: a reporting quantity of uplink beams for the report or downlink reference signal to be measured for the report; and
receiving, from the UE, the report in conformance with the control signaling, the report corresponding to at least one of a beam report for STxMP or a panel status update report for STxMP.

13. The method of claim 12, further comprising:
transmitting, to the UE for an activated panel, the downlink reference signal.

14. The method of claim 12, further comprising:
receiving a UE capability report that indicates UE capabilities for the report, wherein the UE capabilities include at least one of a first maximum number of supported synchronization signal blocks (SSBs) or channel state information-reference signal (CSI-RS) resources for the report or a second maximum number of supported SSBs or CSI-RS resources in a slot for the report.

15. The method of claim 12, further comprising:
receiving a scheduling request for the report; and
transmitting an uplink grant for the receiving, from the UE, the report based on the scheduling request.

16. The method of claim 12, wherein the beam report for STxMP includes at least one of: a beam quality, panel information, or a group of beams associated with STxMP indicated by an index for the downlink reference signals.

17. The method of claim 12, wherein the control signaling indicates one or more of: uplink multiple-input multiple-output (MIMO) parameter sets, wherein at least one of a parameter set of the one or more uplink MIMO parameter sets corresponds to a predefined panel status or each of the one or more uplink MIMO parameter sets corresponds to a respective panel status.

18. The method of claim 12, further comprising:
transmitting at least one of: downlink control information (DCI) or a medium access control-control element (MAC-CE), wherein the DCI triggers an aperiodic beam report for STxMP, and wherein the MAC-CE triggers at least one of a semi-persistent beam report for STxMP or an update to the one or more uplink MIMO parameter sets.

19. An apparatus for wireless communication at a user equipment (UE), comprising:
a transceiver;
a memory; and
a processor coupled to the memory and the transceiver, the processor configured to:
receive, from a network entity, control signaling for transmission of a report associated with simultaneous transmission from multiple panels (STxMP), the control signaling indicating at least one of: a reporting quantity of uplink beams for the report or a downlink reference signal to be measured for the report; and
transmit, to the network entity, the report in conformance with the control signaling, the report corresponding to at least one of a beam report for STxMP or a panel status update report for STxMP.

20. The apparatus of claim 19, wherein the processor configured to:
transmit a UE capability report that indicates UE capabilities for the report, wherein the UE capabilities include at least one of: a first maximum number of supported synchronization signal blocks (SSBs) or channel state information-reference signal (CSI-RS) resources for the report or a second maximum number of supported SSBs or CSI-RS resources in a slot for the report.
